(19) United States
(12) Patent Application Publication
(10) Pub. No.: US 2022/0324458 A1
(43) Pub. Date: Oct. 13, 2022

(54) SYSTEMS AND METHODS FOR ENHANCING IN-CABIN SLEEP EXPERIENCE IN VEHICLE

(71) Applicant: Ford Global Technologies, LLC, Dearborn, MI (US)

(72) Inventors: Cynthia M. Neubecker, Westland, MI (US); Pietro Buttolo, Dearborn Heights, MI (US); Nikhitha Bekkanti, Farmington Hills, MI (US); Karthik Krishnamurthy, Farmington Hills, MI (US); Thomas Chrapkiewicz, Farmington Hills, MI (US)

(73) Assignee: Ford Global Technologies, LLC, Dearborn, MI (US)

(21) Appl. No.: 17/229,778

(22) Filed: Apr. 13, 2021

(51) Int. Cl. B60W 40/08; G06N 20/00; B60W 50/14; B60Q 3/80; B60K 35/00; B60N 2/90

(52) U.S. Cl. CPC B60W 40/08; G06N 20/00; B60W 50/14; B60Q 3/80; B60K 35/00; B60N 2/90; B60K 2370/1529; B60K 2370/157

(57) ABSTRACT

Systems and methods for enhancing in-cabin sleeping experience within a vehicle are provided. The method includes determining whether a first occupant, e.g., a passenger, within the vehicle is asleep based on data captured of an interior of the vehicle, e.g., via one or more cameras within the vehicle. The method further includes informing a second occupant, e.g., a driver, within the vehicle that the first occupant is asleep, and adjusting an interior cabin parameter to accommodate the first occupant. The method further may include adjusting the interior cabin parameter to wake up the first occupant when the vehicle is a predetermined time or distance from a target destination. Moreover, the method may include classifying the first occupant such that the inter cabin parameter is adjusted to accommodate the first occupant based on the classification of the first occupant.

### BACKGROUND

When multiple occupants are in a shared vehicle cabin and at least one of the passengers is sleeping, current vehicle technology is not optimized to enhance the passenger's sleeping experience. For example, the driver of the vehicle may not notice that a passenger is sleeping, and thus, the vehicle audio may be too loud, and/or the driver may answer a phone call loudly. Moreover, in a shared ride journey, awake passengers may be hesitant to wake up a sleeping passenger as they near the sleeping passenger's destination. It is with respect to these and other considerations that the disclosure made herein is presented.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 illustrates an exemplary system for enhancing in-cabin sleeping experience in accordance with the principles of the present disclosure.

FIGS. 2A and 2B illustrate exemplary haptic transducers constructed in accordance with the principles of the present disclosure.

FIG. 3 shows some example components that may be included in an enhanced sleeping experience platform in accordance with the principles of the present disclosure.

FIG. 4 is a flow chart illustrating exemplary steps for enhancing in-cabin sleeping experience in accordance with the principles of the present disclosure.

### DETAILED DESCRIPTION

### Overview

Disclosed is a vehicle system that detects when a vehicle passenger is sleeping, and performs actions to enhance their sleeping experience. For example, the vehicle may inform the driver without waking the passenger by changing the ambient light or lightly vibrating the driver seat. As a second example, the vehicle may perform bi-zone sound modulation. That is, based on the passenger that is asleep, different sounds may be played, e.g., if the passenger is a baby, the parent may configure white noise to play, a lullaby to play, no sound to play, etc. This sound may automatically be played based on the individual passenger detected to be sleeping. As a third example, a close-to-destination wake-up strategy may be enacted in which a wake-up sequence may be enacted when the passenger is a predetermined amount of time and/or distance away from their destination. The wake-up sequence may involve, e.g., ambient light changes, volume changes, haptic feedback in the seat, or inclination of the seat. The same system also may be used to help a user fall asleep, by changing some of the same vehicle conditions, e.g., ambient light, temperature, sound levels, etc.

### Illustrative Embodiments

The disclosure will be described more fully hereinafter with reference to the accompanying drawings, in which example embodiments of the disclosure are shown. This disclosure may, however, be embodied in many different forms and should not be construed as limited to the example embodiments set forth herein. It will be apparent to persons skilled in the relevant art that various changes in form and detail can be made to various embodiments without departing from the spirit and scope of the present disclosure. Thus, the breadth and scope of the present disclosure should not be limited by any of the above-described example embodiments but should be defined only in accordance with the following claims and their equivalents. The description below has been presented for the purposes of illustration and is not intended to be exhaustive or to be limited to the precise form disclosed. It should be understood that alternate implementations may be used in any combination to form additional hybrid implementations of the present disclosure. For example, any of the functionality described with respect to a particular device/component may be performed by another device/component. Further, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments.

Certain words and phrases are used herein solely for convenience and such words and terms should be interpreted as referring to various objects and actions that are generally understood in various forms and equivalencies by persons of ordinary skill in the art.

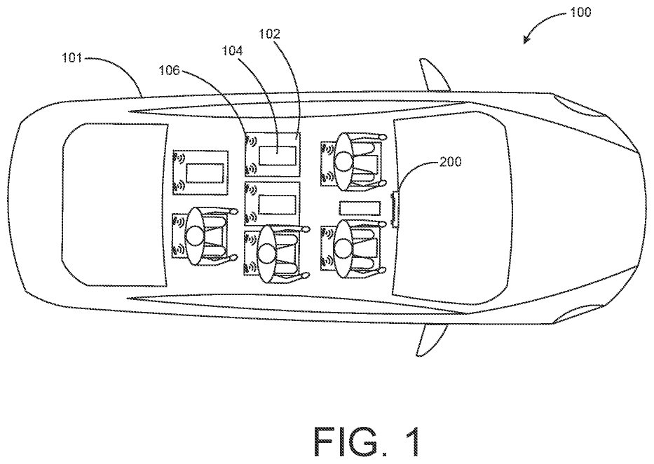

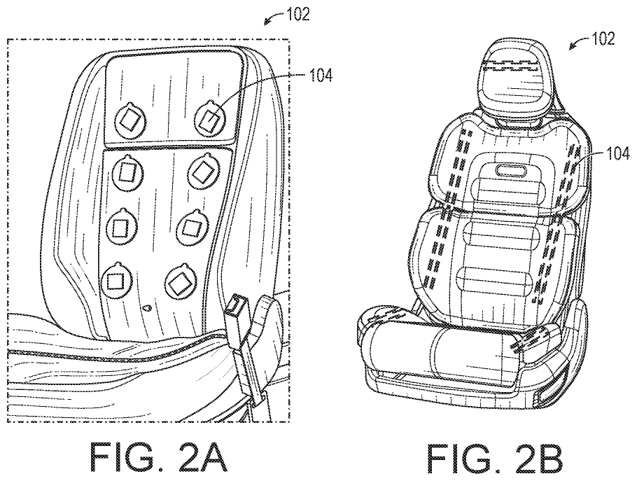

Referring now to FIG. 1, system 100 for enhancing in-cabin sleeping experience within vehicle 101 is provided. As shown in FIG. 1, system 100 may include vehicle 101 having a vehicle control module having enhanced sleeping experience platform 200. System 100 further may include a plurality of sensors and transducers operatively coupled to vehicle 101. For example, system 100 may include haptic transducers 104 operatively coupled to each of seats 102 of vehicle 101, as shown in FIGS. 2A and 2B. As shown in FIG. 2A, each seat 102 may include a plurality of haptic transducers 104 disposed on seat 102, e.g., underneath the seat covering. Haptic transducers 104 are configured to vibrate to thereby create a massaging effect on the passenger sitting on respective seat 102. Haptic transducers 104 may be configured to vibrate and create a soothing, relaxing vibration that may help a passenger fall and/or stay asleep. Alternatively or additionally, haptic transducers 104 may be configured to vibrate and create a more disruptive vibration to help wake a passenger up. As shown in FIG. 2B, haptic transducers 104 may extend linearly along seat 102, and be positioned accordingly to correspond with desired locations on a generic passenger to be vibrated.

Referring again to FIG. 1, system 100 may include one or more sensing devices disposed within the interior of vehicle 101 for capturing data indicative of the interior of vehicle 101, e.g., cameras 106. Accordingly, cameras 106 may capture and optionally record image data indicative of the interior of vehicle 101. The image data may be processed and analyzed to determine whether one or more passengers within vehicle 101 are asleep, as described in further detail below. Alternatively or additionally, the one or more sensing devices may include LIDAR, biometric sensors, etc.

The vehicle control module may be operatively coupled to haptic transducers 104 and cameras 106. For example, the vehicle control module may receive image data from cameras 106, and further may actuate haptic transducers 104 to thereby vibrate and/or massage a passenger sitting in respective seat 102. Moreover, the vehicle control module may be operatively coupled to electrical components of vehicle 101 including, e.g., the audio system of vehicle 101, the lighting system of vehicle 101, the climate control system of vehicle 101, etc. Accordingly, the vehicle control module may change an audio type, e.g., song or sound, of the audio system, and/or change the volume of the audio of the audio system. Moreover, the vehicle control module may change the lighting level of the light system, and/or the climate setting of the climate control system, e.g., heat up or cool the interior of vehicle 101.

The vehicle control module may communicate with any one of the components described above over a network, e.g., any one, or a combination of networks, such as a local area network (LAN), a wide area network (WAN), a telephone network, a cellular network, a cable network, a wireless network, and/or private/public networks, such as the Internet. For example, the network may support communication technologies, such as TCP/IP, Bluetooth, cellular, near-field communication (NFC), Wi-Fi, Wi-Fi direct, machine-to-machine communication, man-to-machine communication, and/or a vehicle-to-everything (V2X) communication.

Vehicle 101 may be a manually driven vehicle (e.g., no autonomy) and/or configured and/or programmed to operate in a fully autonomous (e.g., driverless) mode (e.g., Level-5 autonomy) or in one or more partial autonomy modes which may include driver assist technologies, e.g., adaptive cruise control. Examples of partial autonomy (or driver assist) modes are widely understood in the art as autonomy Levels 1 through 4. A vehicle having a Level-0 autonomous automation may not include autonomous driving features. An autonomous vehicle (AV) having Level-1 autonomy may include a single automated driver assistance feature, such as steering or acceleration assistance. Adaptive cruise control is one such example of a Level-1 autonomous system that includes aspects of both acceleration and steering. Level-2 autonomy in vehicles may provide partial automation of steering and acceleration functionality, where the automated system(s) are supervised by a human driver that performs non-automated operations such as braking and other controls. In some aspects, with Level-2 autonomous features and greater, a primary user may control the vehicle while the user is inside of the vehicle, or in some example embodiments, from a location remote from the vehicle but within a control zone extending up to several meters from the vehicle while it is in remote operation. Level-3 autonomy in a vehicle can provide conditional automation and control of driving features. For example, Level-3 vehicle autonomy typically includes “environmental detection” capabilities, where the vehicle can make informed decisions independently from a present driver, such as accelerating past a slow-moving vehicle, while the present driver remains ready to retake control of the vehicle if the system is unable to execute the task. Level-4 autonomous vehicles can operate independently from a human driver, but may still include human controls for override operation. Level-4 automation may also enable a self-driving mode to intervene responsive to a predefined conditional trigger, such as a road hazard or a system failure. Level-5 autonomy is associated with autonomous vehicle systems that require no human input for operation, and generally do not include human operational driving controls. According to embodiments of the present disclosure, enhanced sleeping experience platform 200 may be configured and/or programmed to operate with a vehicle having a Level-4 or Level-5 autonomous vehicle controller.

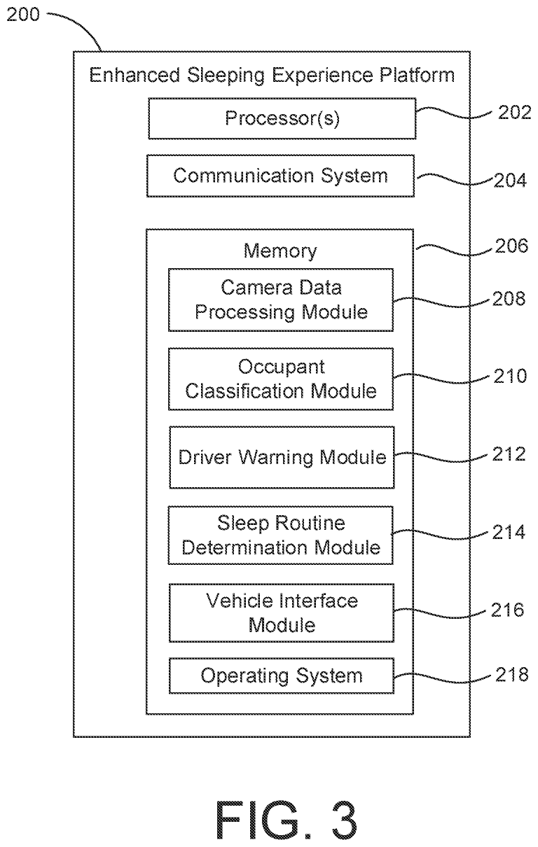

Referring now to FIG. 3, components that may be included in enhanced sleeping experience platform 200 are described in further detail. Enhanced sleeping experience platform 200 may include one or more processors 202, communication system 204, and memory 206. Communication system 204 may include a wireless transceiver that allows enhanced sleeping experience platform 200 to communicate with the electrical components of vehicle 101 including e.g., the lighting system of vehicle 101, the audio system of vehicle 101, the climate controls system of vehicle 101, haptic transducers 104, and cameras 106. The wireless transceiver may use any of various communication formats, such as, for example, an Internet communications format, or a cellular communications format.

Memory 206, which is one example of a non-transitory computer-readable medium, may be used to store operating system (OS) 218, camera data processing module 208, occupant classification module 210, driver warning module 212, sleep routine determination module 214, and vehicle interface module 216. The modules are provided in the form of computer-executable instructions that may be executed by processor 202 for performing various operations in accordance with the disclosure.

Memory 206 may include any one memory element or a combination of volatile memory elements (e.g., random access memory (RAM, such as DRAM, SRAM, SDRAM, etc.)) and non-volatile memory elements (e.g., ROM, hard drive, tape, CDROM, etc.). Moreover, memory 206 may incorporate electronic, magnetic, optical, and/or other types of storage media. In the context of this document, a “non-transitory computer-readable medium” can be, for example but not limited to, an electronic, magnetic, optical, electromagnetic, infrared, or semiconductor system, apparatus, or device. More specific examples (a non-exhaustive list) of the computer-readable medium would include the following: a portable computer diskette (magnetic), a random-access memory (RAM) (electronic), a read-only memory (ROM) (electronic), an erasable programmable read-only memory (EPROM, EEPROM, or Flash memory) (electronic), and a portable compact disc read-only memory (CD ROM) (optical). The computer-readable medium could even be paper or another suitable medium upon which the program is printed, since the program can be electronically captured, for instance, via optical scanning of the paper or other medium, then compiled, interpreted or otherwise processed in a suitable manner if necessary, and then stored in a computer memory.

Camera data processing module 208 may be executed by processor 202 for receiving data from the one or more sensing devices, e.g., image and/or audio data from cameras 106. Moreover, camera data processing module 208 may, based on the captured data, determine whether one or more passengers within vehicle 101 are asleep. For example, camera data processing module 208 may execute algorithms to detect sleep-type behaviors from the data, such as when a passenger has not moved beyond a predetermined threshold within a predetermined amount of time, and/or if the passenger is detected to be snoring based on audio data. In some embodiments, camera data processing module 208 may use machine learning and/or artificial intelligence to determine whether one or more passengers within vehicle 101 based on learned behaviors.

Occupant classification module 210 may be executed by processor 202 for classifying one or more passengers, e.g., sleeping passengers, based on the data received by camera data processing module 208 from cameras 106. For example, occupant classification module 210 may classify each passenger within vehicle 101 as either a baby/infant/toddler, child, or adult, e.g., based on features captured in the received image data. Alternatively, a passenger's classification may be stored, e.g., in the vehicle control module, such that upon detection of the passenger within vehicle 101, e.g., via cameras 106, occupant classification module 210 associates the stored classification to the passenger.

Driver warning module 212 may be executed by processor 202 for, when camera data processing module 208 has determined at least one passenger within vehicle 101 is asleep, actuating one or more interior cabin parameters of vehicle 101 to inform, e.g., a driver of vehicle 101, that at least one passenger is asleep. Driver warning module 212 may actuate one or more interior cabin parameters of vehicle 101 based on the classification of the sleeping passenger determined by occupant classification module 210. For example, driver warning module 212 may cause the audio system of vehicle 101 to lower the volume of the audio and/or change the audio, e.g., song or sound, to indicate that a passenger is asleep, e.g., a lullaby if the passenger is determined to be a baby by occupant classification module 210. Additionally or alternatively, driver warning module 212 may cause the lighting system of vehicle 101 to emit light in a predetermined pattern to indicate that the passenger is asleep, e.g., the lighting system may emit ambient lighting. Moreover, driver warning module 212 may inform the driver that a passenger is asleep by actuating haptic transducers 104 coupled to the seat associated with the driver to thereby cause the driver's seat to vibrate. In some embodiments, driver warning module 212 may inform the driver that a passenger is asleep by causing a heads up display of vehicle 101 to display a message and/or icon indicating that the passenger is asleep. For example, the heads up display may be visible in the driver's line of sight, e.g., on the windshield, to thereby catch the driver's attention.

Sleep routine determination module 214 may be executed by processor 202 for generating a routine configured to adjust one or more interior cabin parameters to accommodate the sleeping passenger. For example, sleep routine determination module 214 may generate a routine whereby the audio system lowers the volume or emits a pre-selected audio such as white noise or a lullaby, the lighting system emits ambient lighting, haptic transducers 104 associated with the seat of the sleeping passenger gently massages the sleeping passenger, the climate control system sets the temperature within vehicle 101 to a preselected temperature, etc. The routine may be generated based on the classification of the sleeping passenger as determined by occupant classification module 210. In some embodiments, routines may be preprogrammed for individual passengers and stored on, e.g., the vehicle control module, such that upon detection of the passenger within vehicle 101, e.g., via cameras 106, sleep routine determination module 214 may receive the passenger's preprogrammed sleeping routine preferences.

Alternatively or additionally, sleep routine determination module 214 may be executed by processor 202 for generating a routine configured to adjust one or more interior cabin parameters to help a passenger fall asleep. Moreover, the routine may include a wake up routine, e.g., based on a predetermined time and/or distance of vehicle 101 from reaching a target destination associated with the sleeping passenger. Accordingly, the routine may include a pattern of actuations by the electrical components of vehicle 101 to wake up the sleeping passengers. For example, the routine may include raising the volume of the audio of the audio system, brightening the lighting within vehicle 101, causing haptic transducers 104 to vibrate to thereby wake up the passenger, etc.

Vehicle interface module 216 may be executed by processor 202 for actuating the electrical components of vehicle 101 to execute the routine generated by sleep routine determination module 214. Specifically, based on the routine, vehicle interface module 216 may cause the audio system to lower the volume and/or emit a pre-selected audio, cause the lighting system to emit ambient lighting, cause haptic transducers 104 associated with the seat of the sleeping passenger to gently massage the sleeping passenger, and/or cause the climate control system to set the temperature within vehicle 101 at a preselected temperature.

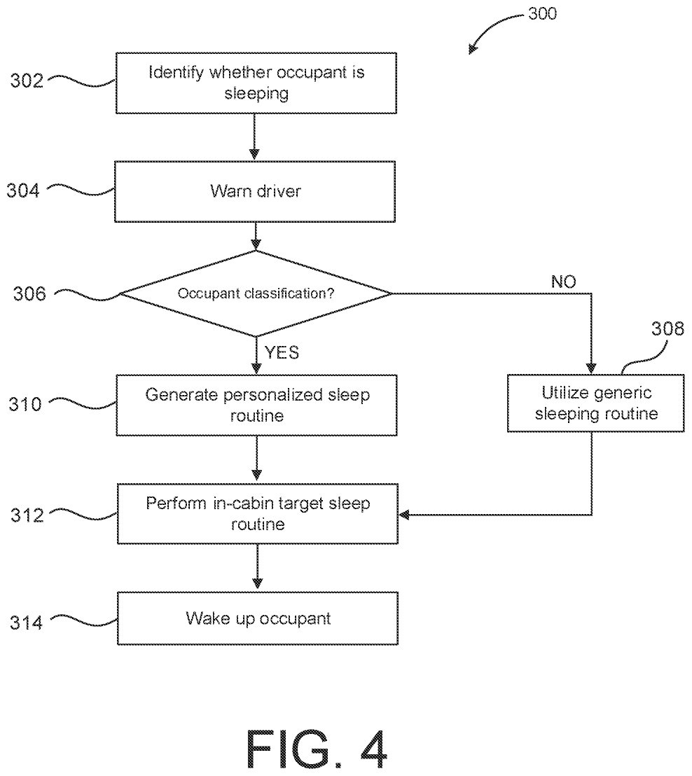

Referring now to FIG. 4, a flow chart illustrating the steps of exemplary method 300 for enhancing in-cabin sleeping experience within vehicle 101 is provided. At step 302, camera data processing module 208 of enhanced sleeping experience platform 200 of system 100 may determine whether one or more occupants of vehicle 101, e.g., passengers, are asleep via, e.g., cameras 106. At step 304, if a passenger is determined to be asleep, driver warning module 212 may actuate one or more interior cabin parameters to inform the driver of vehicle 101 that the passenger is asleep. For example, the audio and/or lighting within vehicle 101 may indicate to the driver that the passenger is asleep, or haptic transducers 104 associated with the driver's seat may vibrate to alert the driver. Alternatively or additionally, the heads up display of vehicle 101 may provide the driver a visual message that a passenger is asleep.

At step 306, method 300 determines whether an occupant classification mode is on, e.g., whether occupant classification module 210 will classify one or more passengers within vehicle 101 based on the captured data. If the occupant classification mode is not on at step 306, method 300 proceeds to step 308. At step 308, sleep routine determination module 214 may generate a generic sleeping routine, e.g., emit ambient lighting and lower the audio level within vehicle 101. If the occupant classification mode is on at step 306, occupant classification module 210 may classify the one or more passengers, and method 300 proceeds to step 310. At step 310, sleep routine determination module 214 may generate a personalized sleep routine based on the classification of the sleeping passengers and/or based on preprogrammed preferences of the passenger. For example, the personalized sleep routine for a baby passenger may include playing white noise or a lullaby. In some embodiments, as described above, the personalized sleep routine may be configured to assist a passenger to fall asleep. In addition, as described above, either the generic routine or the personalized sleep routine may include a wake up routine.

At step 312, either the generic sleeping routine generated at step 308 or the personalized sleep routine generated at step 310 will be executed by vehicle interface module 216 depending on whether or not the occupant classification mode is on. Accordingly, the vehicle control module will actuate the electrical components of vehicle 101 in accordance with the selected routine. At step 314, vehicle interface module 216 may execute the wake up routine and actuate electrical components of vehicle 101 to wake up the passenger, e.g., when vehicle 101 is within a predetermined time or distance from the sleeping passenger's target destination.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, one skilled in the art will recognize such feature, structure, or characteristic in connection with other embodiments whether or not explicitly described.

Implementations of the systems, apparatuses, devices, and methods disclosed herein may comprise or utilize one or more devices that include hardware, such as, for example, one or more processors and system memory, as discussed herein. An implementation of the devices, systems, and methods disclosed herein may communicate over a computer network. A “network” is defined as one or more data links that enable the transport of electronic data between computer systems and/or modules and/or other electronic devices. When information is transferred or provided over a network or another communications connection (either hardwired, wireless, or any combination of hardwired or wireless) to a computer, the computer properly views the connection as a transmission medium. Transmission media can include a network and/or data links, which can be used to carry desired program code means in the form of computer-executable instructions or data structures and which can be accessed by a general purpose or special purpose computer. Combinations of the above should also be included within the scope of non-transitory computer-readable media.

Computer-executable instructions comprise, for example, instructions and data which, when executed at a processor, cause the processor to perform a certain function or group of functions. The computer-executable instructions may be, for example, binaries, intermediate format instructions, such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the present disclosure may be practiced in network computing environments with many types of computer system configurations, including in-dash vehicle computers, personal computers, desktop computers, laptop computers, message processors, handheld devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, and/or wireless data links) through a network, both perform tasks. In a distributed system environment, program modules may be located in both the local and remote memory storage devices.

Further, where appropriate, the functions described herein may be performed in one or more of hardware, software, firmware, digital components, or analog components. For example, one or more application specific integrated circuits (ASICs) may be programmed to carry out one or more of the systems and procedures described herein. Certain terms are used throughout the description, and claims refer to particular system components. As one skilled in the art will appreciate, components may be referred to by different names. This document does not intend to distinguish between components that differ in name, but not function.

At least some embodiments of the present disclosure have been directed to computer program products comprising such logic (e.g., in the form of software) stored on any computer-usable medium. Such software, when executed in one or more data processing devices, causes a device to operate as described herein.

While various embodiments of the present disclosure have been described above, it should be understood that they have been presented by way of example only, and not limitation. It will be apparent to persons skilled in the relevant art that various changes in form and detail can be made therein without departing from the spirit and scope of the present disclosure. Thus, the breadth and scope of the present disclosure should not be limited by any of the above-described example embodiments but should be defined only in accordance with the following claims and their equivalents. The foregoing description has been presented for the purposes of illustration and description. It is not intended to be exhaustive or to limit the present disclosure to the precise form disclosed. Many modifications and variations are possible in light of the above teaching. Further, it should be noted that any or all of the aforementioned alternate implementations may be used in any combination desired to form additional hybrid implementations of the present disclosure. For example, any of the functionality described with respect to a particular device or component may be performed by another device or component. Further, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

What is claimed:

1. A method for enhancing in-cabin sleeping experience within a vehicle, the method comprising:
determining whether a first occupant within the vehicle is asleep based on data captured of an interior of the vehicle;
informing a second occupant within the vehicle that the first occupant is asleep; and
adjusting an interior cabin parameter to accommodate the first occupant.

2. The method of claim 1, wherein the first occupant is a passenger of the vehicle.

3. The method of claim 1, wherein the second occupant is a driver of the vehicle.

4. The method of claim 1, wherein informing the second occupant within the vehicle that the first occupant is asleep comprises adjusting one or more interior cabin parameters comprising at least one of a haptic transducer operatively coupled to a seat of the second occupant, a lighting within the interior of the vehicle, an audio within the interior of the vehicle, or a heads up display.

5. The method of claim 1, wherein adjusting the interior cabin parameter comprises adjusting at least one of a haptic transducer operatively coupled to a seat of the first occupant, a lighting within the interior of the vehicle, or an audio within the interior of the vehicle.

6. The method of claim 1, wherein adjusting the interior cabin parameter comprises adjusting one or more cabin parameters adjacent to the first occupant while not adjusting one or more cabin parameters adjacent to the second occupant.

7. The method of claim 1, further comprising classifying the first occupant based on the data.

8. The method of claim 7, wherein classifying the first occupant comprises classifying whether the first occupant is a baby, a child, or an adult.

9. The method of claim 7, wherein adjusting the interior cabin parameter to accommodate the first occupant is based on the classification of the first occupant.

10. The method of claim 1, further comprising capturing the data of the interior of the vehicle.

11. The method of claim 10, wherein capturing the data of the interior of the vehicle comprises capturing image data via one or more cameras within the vehicle.

12. The method of claim 1, further comprising adjusting one or more interior cabin parameters to wake up the first occupant when the first occupant is within a predetermined time or distance from a target destination.

13. A system for enhancing in-cabin sleeping experience within a vehicle, the system comprising:
a device operatively coupled to the vehicle and configured to capture data indicative of an interior of the vehicle;
a memory that stores computer-executable instructions; and
a processor configured to access the memory and execute the computer-executable instructions to:
determine whether a first occupant within the vehicle is asleep based on the data;
actuate a first set of interior cabin parameters to inform a second occupant that the first occupant is asleep; and
generate and execute a routine configured to adjust a second set of interior cabin parameters to accommodate the first occupant.

14. The system of claim 13, wherein the first set of interior cabin parameters comprise at least one of a haptic transducer operatively coupled to a seat of the second occupant, a lighting within the interior of the vehicle, an audio within the interior of the vehicle, or a heads up display.

15. The system of claim 13, wherein the second set of interior cabin parameters comprise at least one of a haptic transducer operatively coupled to a seat of the first occupant, a lighting within the interior of the vehicle, or an audio within the interior of the vehicle.

16. The system of claim 13, wherein the processor is further configured to classify the first occupant based on the data.

17. The system of claim 16, wherein the processor is configured to classify whether the first occupant is a baby, a child, or an adult.

18. The system of claim 16, wherein the processor is configured to generate the routine based on the classification of the first occupant.

19. The system of claim 13, wherein the processor is further configured to adjust a third set of interior cabin parameters to wake up the first occupant when the vehicle is within a predetermined time or distance from a target destination.

20. The system of claim 13, wherein the routine configured to adjust the second set of interior cabin parameters is configured to adjust interior cabin parameters adjacent to the first occupant but not interior cabin parameters adjacent to the second occupant.
